(19) United States
(12) Patent Application Publication
(10) Pub. No.: US 2024/0195206 A1
(43) Pub. Date: Jun. 13, 2024

(54) METHODS AND SYSTEMS OF AGING-AWARE CHARGING PROFILE DETERMINATION FOR A BATTERY SYSTEM

(71) Applicant: Cummins Inc., Columbus, IN (US)

(72) Inventors: Manilk Narula, Columbus, IN (US); Xing Jin, Columbus, IN (US); Kenneth M. Follen, Greenwood, IN (US); Dat Duc Le, Columbus, IN (US); Gary L. Parker, Columbus, IN (US); Ruigang Zhang, Bargersville, IN (US)

(21) Appl. No.: 18/287,570

(22) PCT Filed: Apr. 22, 2022
(86) PCT No.: PCT/US2022/025991

§ 371 Date: Oct. 19, 2023

Related U.S. Application Data
(60) Provisional application No. 63/178,700, filed on Apr. 23, 2021.

(51) Int. Cl. H02J 7/00; B60L 7/10; B60L 53/62; B60L 53/68; H01M 10/0525; H01M 10/44

(52) U.S. Cl. CPC H02J 7/007188; H01M 10/0525; H01M 10/441; H02J 7/00036; H02J 7/0013; H02J 7/005; B60L 7/10; B60L 53/62; B60L 53/68; H01M 2220/20; H02J 7/0071

(57) ABSTRACT

A system for charging a battery is provided, in which the system includes a plurality of sensors coupled with the battery, at least one battery charger coupled with the battery, and a processing unit coupled with the sensors and the battery charger. The processing unit includes a battery degradation modeling module and an aging-aware battery charging strategy module. The processing unit receives sensor information from the sensors, uses the battery degradation modeling module to detect aging phenomena or mechanisms that cause aging effect of the battery with a degradation model of the battery based on the sensor information, uses the aging-aware battery charging strategy module to calculate a charging profile for the battery based on the aging effect of the battery and the sensor information, and controls the battery charger to charge the battery based on the charging profile.

### FIELD OF THE DISCLOSURE

The present disclosure relates generally to energy storage systems and more specifically to those implementing batteries.

### BACKGROUND OF THE DISCLOSURE

The constant current (CC), multistage constant current (MCC), and constant-current constant-voltage (CCCV) charging protocols have been widely used for batteries such as lithium-ion batteries, NiMH batteries, etc. These methods are designed based on predefined limits such as voltage and current, and fail to take into consideration the batteries' internal state information such as their age and condition. As such, these methods may be too conservative for new batteries and too aggressive for aged batteries. If the charging strategy is too conservative, it would take longer for batteries to charge, and if the charging strategy is too aggressive, it would cause degradation in the batteries' internal components. Accordingly, further contributions are needed in this area of technology to implement flexibility in the battery charging strategy that takes into consideration the conditions of the batteries in order to extend the life of the batteries as well as to ensure safety and improved reliability for those who use them.

### SUMMARY OF THE DISCLOSURE

According to the present disclosure, a system for charging a battery is provided. The system includes a plurality of sensors coupled with the battery, at least one battery charger coupled with the battery, and a processing unit coupled with the sensors and the battery charger. The processing unit includes a battery degradation modeling module and an aging-aware battery charging strategy module. The processing unit receives sensor information from the sensors, uses the battery degradation modeling module to detect or predict an aging phenomenon or mechanism (or a plurality of aging phenomena or mechanisms) that causes aging effect of the battery with a degradation model of the battery based on the sensor information, uses the aging-aware battery charging strategy module to calculate a charging profile for the battery based on the aging effect of the battery and the sensor information, and controls the battery charger to charge the battery based on the charging profile.

In some examples, the aging effect includes one or more of: capacity loss, power loss, or internal resistance increase within the battery. In some examples, the aging phenomenon or mechanism includes one or more of: electrolyte oxidation, transition metal dissolution, anode or cathode film growth, or active material loss within the battery. In some examples, the battery is a lithium-ion battery and the aging phenomenon or mechanism includes one or more of: solid electrolyte interphase (SEI) layer growth, cathode film growth, active material loss, dendrite growth, or lithium plating within the battery. In some examples, the charging profile includes battery charging current or power values and a degradation status of the battery.

In some examples, at least one battery charger includes a plurality of charging stations for a corresponding plurality of the vehicles, and the charging profile includes a plurality of charging profiles for a plurality of batteries corresponding to the plurality of vehicles. In some examples, the processing unit further calculates a charging schedule for the vehicles using the charging stations based on the charging profiles.

Also disclosed herein is a hybrid vehicle system that includes a hybrid vehicle and a processing unit. The hybrid vehicle includes an engine, an aftertreatment system coupled with the engine, a motor/generator, at least one battery coupled with the motor/generator, and a plurality of sensors coupled with the battery and the aftertreatment system. The processing unit is coupled with the sensors and the motor/generator and includes a battery degradation modeling module and an aging-aware battery charging strategy module. The processing unit receives sensor information from the sensors, uses the battery degradation modeling module to detect or predict an aging phenomenon or mechanism that causes aging effect of the battery with a degradation model of the battery based on the sensor information, and uses the aging-aware battery charging strategy module to calculate a charging profile for the battery based on the aging effect of the battery and the sensor information.

In some examples, the processing unit further calculates a generator power and an engine power based on the charging profile, and the calculated generator power and the engine power facilitate maintaining the aftertreatment system at or above a minimum threshold temperature. In some examples, the processing unit activates an electric heater operatively coupled with the aftertreatment system to maintain the aftertreatment system at or above the minimum threshold temperature. In some examples, the processor controls the engine to provide mechanical power to the motor/generator to charge the battery based on the charging profile. In some examples, the processing unit further controls the motor/generator to capture regenerative braking energy based on the charging profile.

Also disclosed herein is a method of charging a battery. The method includes: receiving, by a processing unit, sensor information from a plurality of sensors coupled with the battery; detecting or predicting, by a battery degradation modeling module of the processing unit, an aging phenomenon or mechanism that causes aging effect of the battery using a degradation model of the battery based on the sensor information; calculating, by an aging-aware battery charging strategy module of the processing unit, a charging profile for the battery based on the aging effect of the battery and the sensor information; and controlling a battery charger coupled with the battery to charge the battery based on the charging profile.

In some examples, the aging effect includes one or more of: capacity loss, power loss, or internal resistance increase within the battery. In some examples, the aging phenomenon or mechanism includes one or more of: electrolyte oxidation, transition metal dissolution, anode or cathode film growth, or active material loss within the battery. In some examples, the battery is a lithium-ion battery and the aging phenomenon or mechanism includes one or more of: SEI layer growth, cathode film growth, active material loss, dendrite growth, or lithium plating within the battery. In some examples, the charging profile includes battery charging current or power values and a degradation status of the battery.

In some examples, the method further includes: calculating, by the aging-aware battery charging strategy module, a plurality of charging profiles for a plurality of batteries implemented in a plurality of vehicles. The charging profiles are based on the aging effect of the batteries, and calculating, by the aging-aware battery charging strategy module, a charging schedule for a plurality of vehicles based on the charging profiles.

In some examples, the battery is implemented in a hybrid vehicle which includes an engine, an aftertreatment system coupled with the engine and the sensors, and a motor/generator coupled with the battery. In such cases, the method further includes receiving, by the processing unit, sensor information from the sensors coupled with the aftertreatment system and calculating, by the aging-aware battery charging strategy module, a charging profile for the battery based on the aging phenomenon or mechanism that causes aging effect of the battery and the sensor information associated with the aftertreatment system. In some examples, the method further includes calculating, by the processor, a generator power and an engine power based on the charging profile. The calculated generator power and the engine power facilitate maintaining the aftertreatment system at or above a minimum threshold temperature. In some examples, the method further includes controlling, by the processor, the motor/generator to capture regenerative braking energy based on the charging profile. In some examples, the hybrid vehicle includes an electric heater configured to maintain the aftertreatment system at or above the minimum threshold temperature. In some examples, the engine is configured to provide mechanical power to the motor/generator to charge the battery based on the charging profile.

In some examples, the processor, the battery, and the battery charger are wirelessly connected via a cloud network such that the processor is located remotely from the battery and the battery charger. In such cases, the method further includes: wirelessly receiving, by the processor via the cloud network, the sensor information from the sensors coupled with the battery; wirelessly transmitting, by the processor via the cloud network, the calculated charging profile to a secondary processor coupled with the battery or the battery charger; and controlling, by the secondary processor, charging of the battery based on the charging profile. In some examples, a non-transient computer readable storage medium is coupled with the processor such that the non-transient computer readable storage medium stores instructions, for example computer software codes, which when run on the processor causes the processor to perform the method as explained herein.

While multiple embodiments are disclosed, still other embodiments of the present disclosure will become apparent to those skilled in the art from the following detailed description, which shows and describes illustrative embodiments of the present disclosure. Accordingly, the drawings and detailed description are to be regarded as illustrative in nature and not restrictive.

### BRIEF DESCRIPTION OF THE DRAWINGS

The detailed description of drawings particularly refers to the accompanying figures in which:

FIG. 1 shows the schematic diagram of a battery charging system according to embodiments disclosed herein;

FIG. 2 shows the schematic diagram of a processing unit as implemented with the components of the battery charging system shown in FIG. 1;

FIG. 3 shows the graphs of a battery's charging current magnitude vs time and a battery's state of charge (SOC) vs time when implementing two different charging profiles based on differing aging effects of the batteries, according to embodiments disclosed herein;

FIG. 4 shows the flowchart of a method of charging a battery according to embodiments disclosed herein;

FIG. 5 shows the schematic diagram of a battery fleet system implementing a plurality of batteries and a plurality of battery chargers according to embodiments disclosed herein;

FIG. 6 shows the flowchart of a method of charging a fleet of batteries according to embodiments disclosed herein;

FIG. 7 shows the charging profile of an SOC-based charging strategy as known in the art;

FIG. 8 shows the charging profile of an aging-aware battery charging strategy which takes into consideration the aftertreatment temperature, according to embodiments disclosed herein;

FIG. 9 shows the schematic diagram of a hybrid vehicle system implementing the aging-aware battery charging strategy of FIG. 8;

FIG. 10 shows the flowchart of a method of charging a battery according to embodiments disclosed herein;

FIG. 11 shows a graph of power demand vs time, and a graph of battery current vs time which implements a prior-art regenerative braking strategy and an aging-aware regenerative braking strategy according to embodiments disclosed herein;

FIG. 12 shows the flowchart of a method of charging a battery via aging-aware regenerative braking strategy according to embodiments disclosed herein; and

FIG. 13 shows the schematic diagram of a cloud-implemented battery-charging system according to some embodiments disclosed herein.

### DETAILED DESCRIPTION

The embodiments of the disclosure described herein are not intended to be exhaustive or to limit the disclosure to the precise forms disclosed. Rather, the embodiments selected for description have been chosen to enable one skilled in the art to practice the disclosure.

One of ordinary skill in the art will realize that the embodiments provided can be implemented in hardware, software, firmware, and/or a combination thereof. For example, the controllers disclosed herein may form a portion of a processing subsystem including one or more computing devices having memory, processing, and communication hardware. The controllers may be a single device or a distributed device, and the functions of the controllers may be performed by hardware and/or as computer instructions on a non-transient or non-transitory computer readable storage medium. For example, the computer instructions or programming code in the controller (e.g., an electronic control module or “ECM”) may be implemented in any viable programming language such as C, C++, HTML, XTML, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

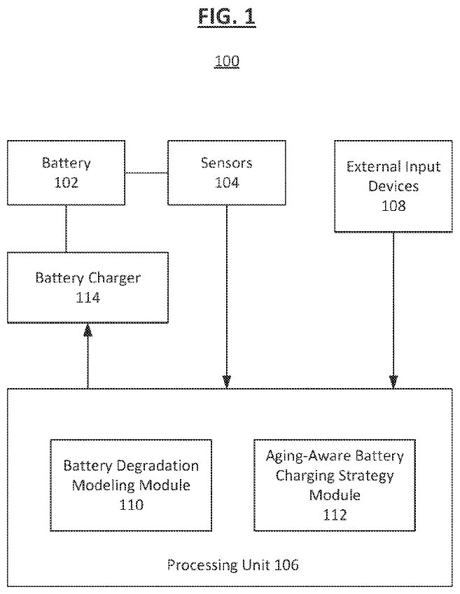

FIG. 1 shows an example of a battery charging system 100 which includes at least one battery 102, a plurality of sensors 104 that take different measurements regarding the conditions of the battery, a processing unit 106 that receives as inputs the measurements from the sensors 104 as well as from one or more external input devices 108, which may provide additional input information that cannot be provided by the sensors 104 alone. Inside the processing unit 106, which may be a computer, or any suitable processor implemented to perform certain operations and/or calculations as further defined herein, are a battery degradation modeling module 110 and an aging-aware battery charging strategy module 112. The aging-aware battery charging strategy module 112 calculates a charging profile with specific strategy to be implemented for the specific battery 102 that is to be charged, and the charging profile is received and implemented by a battery charger 114 such that the processing unit 106 controls the operation of the charger 114, or more specifically a magnitude of the charging current as well as the charging time (initial and total) and capacity loss of the battery, for example, as further explained herein, according to the calculated charging profile. It is to be understood that the battery charger 114 may represent any suitable device or mechanism which facilitates charging of the battery 102, as further discussed herein, including but not limited to a power cord or power outlet for in-home charging, a charging station for electric vehicles, a genset, a motor-generator for regenerative braking, etc.

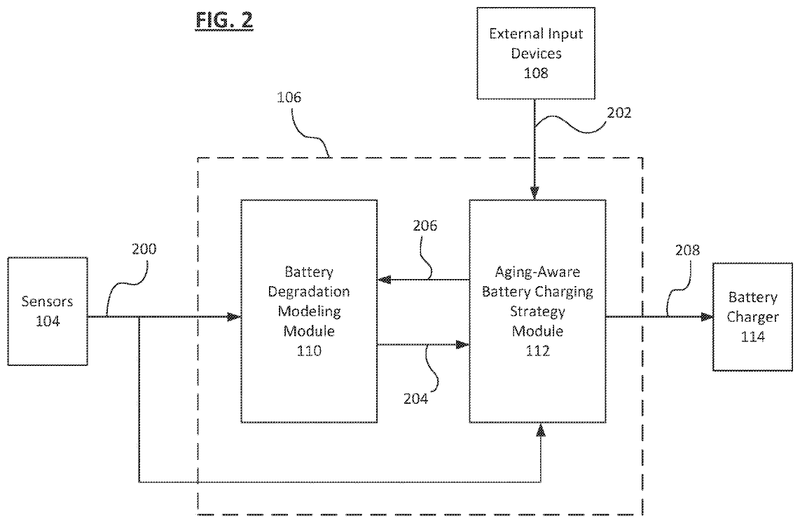

FIG. 2 shows the data flow among the components shown in FIG. 1, as well as different types of data that can be transmitted therebetween. Each of the components is electrically coupled with at least one other component as shown. Depending on the battery charging profile that is implemented by the aging-aware battery charging strategy module 112, the data being transferred may vary, since different charging methods require different inputs for the module 112. The different methods are explained herein.

In some examples, the sensors 104 may be part of a battery management system (BMS) and provide information 200 regarding the battery 102 including, but not limited to, the battery performance, battery temperature (T_{Bat}), battery current (I), battery voltage (Vₜ), and/or battery state of charge (SOC). The external devices 108 may provide information 202 different from those provided by the sensors, such as fleet operation information (when the battery is part of a fleet or group of batteries that are monitored together), infrastructure availability for battery charging (for example, charging stations), ambient condition information (for example, external temperature and humidity), charger status information (for example, types of charger that are available for use), user inputs (for example, user command to override the strategy), or other vehicle component status information (if the battery is incorporated in a vehicle system), etc.

In some examples, the external devices 108 that provide input include, but are not limited to: external server, external computing device, portable computing device with user interface, on-board computing device as implemented in a vehicle that uses the battery, traffic monitoring system, fleet operation monitoring system, weather forecast system, battery charger status monitoring device, vehicle component health monitoring system, ambient condition monitoring system, etc. The different devices or systems may be coupled with the processing unit 106 via wired (for example, data bus) or wireless connection (for example, via Internet, cloud network, infrared, Bluetooth, etc.) for data transmission. The devices 108 are “external” in the sense that they are implemented outside of the processing unit 106 and therefore do not necessarily need to be implemented external with respect to the system (for example, electric vehicle system or generator system) in which the battery is implemented.

The battery degradation modeling module 110 takes the sensor information 200 and uses a degradation model to detect (or predict) how much degradation is experienced (or to be experienced) by the battery 102. The degradation model may be any suitable electrothermal or electrochemical aging model, for example, that is created and/or updated by the module 110 depending on any change in the status of the battery 102 so as to keep the model up-to-date in order to improve the accuracy of the battery degradation as detected or predicted by the model. In some examples, the model may be in the form of a graphical representation of capacity loss of the battery over time. In some examples, the model may be represented as a table such as a lookup table indicating the battery degradation over time, among others. The battery degradation modeling module 110 uses the detected or predicted amount of battery degradation in order to detect the presence of aging phenomena or mechanisms which cause such degradation, as well as the specific type of such aging phenomena or mechanisms which may be the cause of battery degradation. The initial degradation model may be obtained via experimental data or calculational data, and the model may be subsequently updated by the battery degradation modeling module 110 based on the change in the status of the battery 102, for example. Therefore, the battery degradation modeling module 110 may be coupled with a memory device to store the model (initial model and/or current model) for future updates, as well as any historical data regarding the battery status based on which the model may be updated. The model may be updated or calibrated using real measurements or non-real measurements obtained from mathematical calculations based on the obtained data of the battery, such as via machine learning or any other suitable algorithm.

From the degradation model, the battery degradation modeling module 110 outputs information 204 that is consistent with the condition of the battery. Any suitable type of battery may be implemented, including but not limited to lithium-ion batteries, lead-acid batteries, NiMH batteries, solid state batteries, sodium batteries, etc. Different types of batteries have different symptoms of aging and degradation, as recognized by the degradation models. The battery condition may include information such as the aging phenomena or mechanisms that are prevalent in batteries as they age, such as the amount of film growth, active material loss, electrolyte oxidation, transition metal dissolution, anode or cathode film growth, and/or lithium plating within the battery (if the battery is a lithium-ion battery) etc., all of which are factors that contribute to reduced functionality of the battery. In some examples, other factors such as any changes in the morphology and properties of a solid electrolyte interphase (SEI), such as the density, cohesive energy, solubility, and porosity, which are associated with SEI performance, as well as electrolyte conductivity or diffusivity reduction, may be taken into consideration as factors of battery degradation, if the battery is lithium-ion battery. Aging phenomena or mechanisms that pertain to lithium-ion batteries may include the amount of SEI layer growth, cathode film growth, active material loss, dendrite growth, or lithium plating within the battery, for example. The information 204 of the battery degradation modeling module 110 may include, but are not limited to, capacity loss, power loss, or increase in internal resistance within the battery as detected or predicted by the battery degradation modeling module 110 based on the sensor information 200. The outputted information 204 is then transmitted to the aging-aware battery charging strategy module 112.

The aging-aware battery charging strategy module 112 operates to receive the information 200, 202, and 204 as inputs and uses an optimal charging strategy algorithm to calculate a battery charging profile which takes into account the magnitude of charging current demand as a function of time, i.e., I_{dmd} (t), the total charging time, the total capacity loss, and the initial charging time, for example. The module 112 then transmits some of the profile information (as information 206) to the battery degradation modeling module 110 to assist the battery degradation modeling module 110 in updating the degradation model of the battery. The module 112 also transmits some of the profile information (as information 208) to the battery charger 114 to control how the battery charger 114 charges the battery. More specifically, the information 206 may include the battery's capacity loss such that the degradation model can reflect the reduction in the battery capacity, and the information 208 may include the I_{dmd} (t) profile as well as when the battery needs to start charging (initial charging time) and for how long the battery should be charged (total charging time).

In embodiments as disclosed herein, the algorithm may use an optimization strategy that implements the following equation, also referred to as a general aging-aware optimization objective function:

S=min.{(γ*X)+[(1−γ)*Y]} (Equation 1)

where S is the charging strategy, X is a first component of the objective function, and Y is a second component of the objective function. Accordingly, γ is the strategy weight factor for the component X, and (1−γ) is the strategy weight factor for the component Y. The “min.” indicates the goal of the charging strategy, which is to minimize the values of X and Y based on the value of γ. In many instances, reducing one of the components X or Y causes the value of the other component to be increased. As such, the strategy weight factor γ affects how much weight is distributed between the two different components such that the algorithm can focus on which component to minimize. Different components of the objective function may be implemented in different cases, and the components can each contribute a benefit that is preferred in certain situations.

In some examples, the first component X may be the charging time for the battery, and the second component Y may be an aging effect of the battery, such as the capacity loss of the battery. In some examples, the first component X may be the charging time for the battery, and the second component Y may be the heat generation, or temperature rise of the battery during charging. In some examples, the components may involve reducing the power loss and/or reduce the rate at which the internal resistance of the battery increases due to battery aging. Other components such as other aging effects may also be included, as suitable.

In a variation of Equation 1, hereinafter referred to as Equation 1A, there may be more than two charging strategy components, as shown in the below general aging-aware optimization objective function:

S=min.{(α*X)+(β*Y)+ . . . +(γ*N)} (Equation 1A)

where S is the charging strategy, X is a first component of the objective function, Y is the second component the objective function, and N is the nth component the objective function, where n is any integer greater than 2. Accordingly, α is the strategy weight factor for the component X, β is the strategy weight factor for the component Y, and γ is the strategy weight factor for the component N. As such, Equation 1A includes a total of n different components in the objective function, each of which has its own strategy weight factor. Any of the equations disclosed herein may be altered to include more than two components in the objective function.

In some examples, Equation 1 may be modified as shown below:

S=min.{γ*t_{charge})+[(1−γ)*W*Qₗₒₛₛ]} (Equation 2)

where S is the charging strategy, t_{charge} is the charging time for the battery, Qₗₒₛₛ is the capacity loss of the battery, W is the capacity loss weighting factor, and γ is the strategy weight factor. The “min.” indicates the goal of the charging strategy, which is to minimize the values of t_{charge} and Qₗₒₛₛ based on the value of γ. The strategy weight factor γ affects how much weight is distributed between the charging time and the capacity loss. For example, the first component of the objective function, γ*t_{charge}, pertains to the aging-aware minimum-time charging strategy, and the second component of the objective function, (1−γ)*W*Qₗₒₛₛ, pertains to the aging-aware minimum-capacity-loss charging strategy. In minimum-time charging, emphasis is placed on having the battery charged in as little time as possible (minimizing or reducing t_{charge}), therefore increasing the amplitude of the charging current to achieve the same SOC level. In minimum-capacity-loss charging, emphasis is placed on conserving the battery capacity (minimizing or reducing Qₗₒₛₛ) such that the battery life may be prolonged, therefore decreasing the amplitude of the charging current because aggressive charging contributes to the degradation of the components of the battery.

The strategy weight factor γ allows for the charging profile to achieve a balanced strategy between the two components. For example, if charging the battery in a short period of time is equally important as conserving the battery capacity, the value of γ may be 0.5 to accommodate a half-and-half strategy. If the user wishes to charge the battery as fast as possible, the value of γ may be 1. If the user has plenty of time to charge the battery and wishes to focus on prolonging battery life, the value of γ may be 0. Any other value between 0 and 1 may be selected for γ based on the inputted information.

In some examples, the optimal aging-aware charging strategy for the battery is subject to certain conditions that need to be met. For example, the final SOC at the end of the charging time equals the target SOC value that is specified by the system or demanded by the user, the local overpotential is no less than a nonzero threshold overpotential value to avoid lithium plating for a lithium-ion battery, the cell temperature is between the minimum and maximum threshold temperature values as specified for the battery during the entirety of the charging time, and/or the cell terminal voltage is between the minimum and maximum threshold voltage values as specified for the battery, etc.

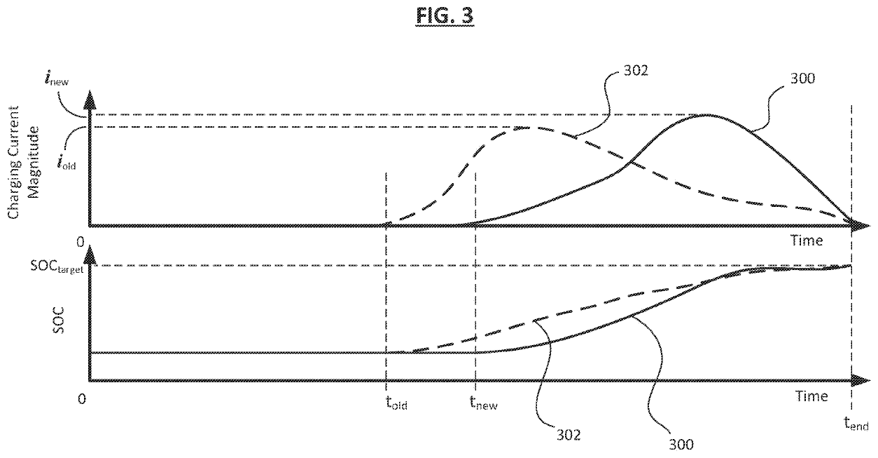

FIG. 3 shows two graphs, charging current magnitude vs time (top) and SOC vs time (bottom), where two different batteries' charging profiles are compared. The top graph represents the magnitude of the charging current that is used to charge the battery at any given time, and the bottom graph represents the charge in each of the batteries at any given time. A solid curve 300 shows the charging profile for a “fresh” battery, while a broken curve 302 shows the charging profile for an “aged” battery that has experienced more degradation than the fresh battery. Hereinafter, it is to be understood that the words “fresh” and “aged” are relative terms that do not necessarily indicate the age of the batteries, but rather the amount of degradation experienced by the individual batteries. For example, even if these two batteries were manufactured at the same time, the “aged” battery may have more degradation due to experiencing more aggressive charging schedules that contributed to its aging effect. As such, for the purpose of this disclosure, the “aged” battery is defined as having more degradation than the “fresh” battery.

As can be seen in the charging current graph, the two curves 300 and 302 reach different maximum current magnitudes. Specifically, the maximum current/new applied to the fresh battery is greater than the maximum current i_{old} applied to the old battery. The profile with the lower maximum current magnitude is less aggressive in the charging strategy, and therefore is implemented to prolong battery life of the aged battery by reducing further degradation. The profile with the high maximum current magnitude, on the other hand, is more aggressive in the charging strategy such that the battery can be charged to the target SOC (SOC_{target}) sooner. The charging profiles of the two batteries also implement different charging start times depending on the level of battery degradation, as shown. In both cases, the batteries are plugged into the charging device at t=0 and are expected to reach SOC_{target} at t=t_{end}, which is the designated end time of the battery charging. The value of t_{end} may be specified by the user (e.g., urgent charging may require earlier end time), predetermined, or set at a specific time of the day (e.g., t_{end} may be set at 8 AM every morning on weekdays for the user to be able to use the battery during the work day).

However, the batteries do not begin charging as soon as they are plugged in at t=0 for various reasons. For example, the charging may be delayed such that power consumption takes place during the time of the day when electricity is offered at a lower price by the electricity company if the company implements time-of-day pricing. Alternatively, the charging may be delayed so as to prevent the battery charging to coincide with other electricity usage, such as with household appliances. In other examples, the charging may be delayed to purely reduce the degradation effect due to calendar aging, since higher SOC leads to greater calendar aging. Therefore, the aged battery does not start charging until t=t_{old}, and the fresh battery does not start charging until t=t_{new}. The starting time of the fresh battery is later than the starting time of the aged battery because the fresh battery is charged at a greater maximum charging current magnitude than the aged battery, so it takes less time to charge to SOC_{target}.

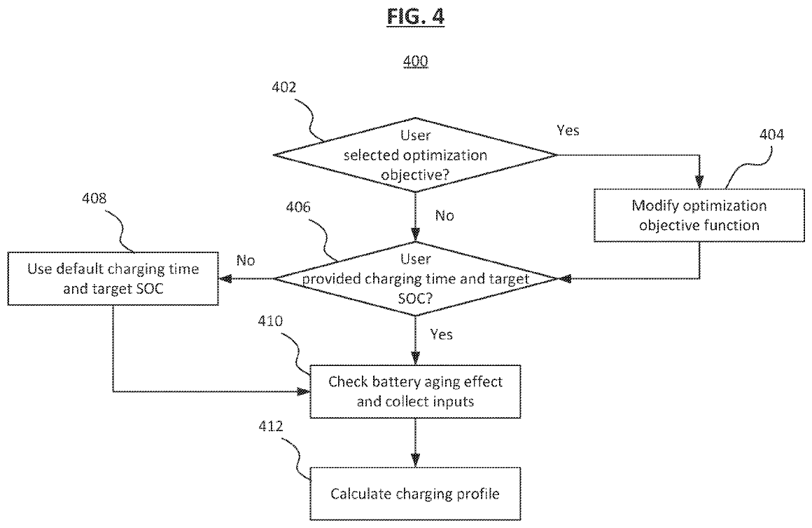

FIG. 4 shows an example of a method 400 implemented by the processing unit to calculate the charging profile for the battery, according to some embodiments. In step 402, the processing unit determines if the user selected an optimization objective. The optimization objective may be an instruction provided by the user to specify how the user prefers the battery to be charged. For example, as previously mentioned, the user may specify that the battery must be charged in the shortest time possible, in which case the value of γ is 1 in Equation 2. Alternatively, the user may wish to prevent as much of the battery degradation as possible, in which case the value of γ is 0 in Equation 2. Although these are the two most extreme cases, in some examples, the user may be able to select the specific γ value for greater flexibility in the amount of control that the user can have on the charging profile.

If the user provided the optimization objective in step 402, in step 404, the optimization objective function (that is, Equation 2) is modified accordingly, after which the processing unit proceeds to step 406. If there is no user-provided objective, the processing unit proceeds from step 402 to 406. In step 406, the user may provide the available charging time and the target SOC for the battery. That is, the user may specify t_{end} and SOC_{target} shown in FIG. 3. If these values are provided, the processing unit proceeds to step 410, otherwise the processing unit proceeds to step 408 to use the default available charging time and the default target SOC value before proceeding to step 410. In step 410, an aging effect (or effect of aging) of the battery is checked, for example by the sensors that monitor the health of the battery, and the inputs are collected by the processing unit. The aging effect that is caused by any of the aging phenomena or mechanisms as disclosed herein. Then, in step 412, the inputs are used by the processing unit to calculate the charging profile. It is to be understood that step 412 utilizes both the battery degradation modeling module 110 to detect or predict the amount of degradation experienced by the battery and the aging-aware battery charging strategy module 112 to use the battery degradation information and the inputs to calculate the charging profile of the battery, using the optimization strategy described by Equation 2 as modified accordingly. In examples where the user did not select an optimization objective, the processing unit may calculate the charging profile such that the charging time and the capacity loss are both reduced as much as possible so as to reduce the degradation of the battery while be able to fully charge the battery in the given amount of time.

In view of FIGS. 3 and 4, the processing unit may be configured to calculate the optimal time to initiate the battery charging, that is, t_{new} or t_{old}, in view of the available charging time (either the default charging time or the time inputted by the user), the initial SOC of the battery, the ambient conditions such as ambient temperature (which may be measured by an external thermometer as one of the external input devices 108, for example), and/or changes in the aging effect according to the degradation model. The ambient temperature may have greater effect on the charging profile when the battery is not charging at room temperature; for example, in an environment with higher temperature, the amplitude of the charging current may be decreased to reduce the risk of capacity loss and battery degradation, which t_{end} to occur more when the battery temperature is too warm. As such, the aging-aware battery charging strategy can generate a battery charging profile that achieves the target SOC, stays within the preferred battery temperature region, and reduces the impact of battery degradation.

### Case 1: Overnight Charging

In some examples, the charging profile may be calculated to accommodate for overnight charging by automatically calculating the initial charging time in order to reduce the degradation effect. In some examples, the degradation effect includes capacity loss, power loss, and/or internal resistance increase within the battery, all of which may be due to battery aging. As previously mentioned, in such overnight charging scenarios, the charging profile may be calculated such that the battery is charged to target SOC at the same time every day during the week, such as at 8 AM. In some examples, the available charging time may be learned from previous tasks (for example, routine charging schedule as tracked by the processing unit) or connected systems (for example, external devices). Also, the status of the battery charger 114 may be used as an input for the aging-aware battery charging strategy module 112 because the preferred charger may be already occupied and charging another battery, in which case the charging of the battery may be delayed until the current battery finishes charging, or the user may need to find a different charger.

In the aforementioned cases of overnight charging, the algorithm may use an optimization strategy that implements the following aging-aware overnight-charging objective function equation:

S=min.[(1−γ)Qₗₒₛₛ] (Equation 3)

where S is the charging strategy, Qₗₒₛₛ is the capacity loss of the battery, and γ is the strategy weight factor. Because the charging happens overnight, in which case there is usually more than enough time for the battery to be charged to reach target SOC, minimizing the t_{charge} value is no longer necessary as shown in Equation 2, so the first component, γ*t_{charge}, of Equation 2 may be removed entirely. Equation 3 is subject to conditions such as the initial Qₗₒₛₛ being a function of the aging effect, as well as meeting the overpotential, cell temperature, and cell terminal voltage requirements as previously discussed herein. In some examples, the word “overnight” may be interpreted simply as having an excess amount of time for battery charging, instead of referring to the time of the day during which the battery is being charged. As such, Equation 3 may be implemented when the available time is longer than the time required to fully charge the battery.

### Case 2: Fleet System

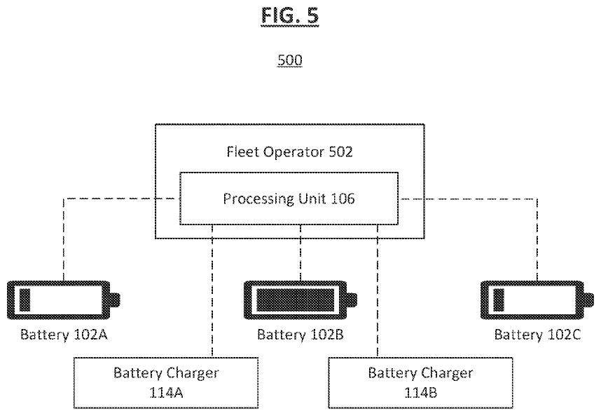

FIG. 5 shows a battery fleet system 500 which implements a plurality of batteries 102A, 102B, and 102C and a plurality of battery chargers 114A and 114B that are linked, e.g. wirelessly via a network, with the processing unit 106 of a fleet operator 502. The fleet operator 502 may be implemented as a central server or central control unit which oversees how the battery chargers 114 are operated to charge the batteries 102. Any number of batteries and battery chargers may be implemented in the battery fleet system 500. The batteries may be implemented in vehicles such as electric vehicles or hybrid vehicles, and the battery chargers may be charging stations dispersed throughout the area which are controlled by the fleet operator 502 according to the calculated charging profile for each of the batteries. As such, the batteries and the chargers may be located in different locations throughout a geographical area, and the locations may change as the vehicles travel.

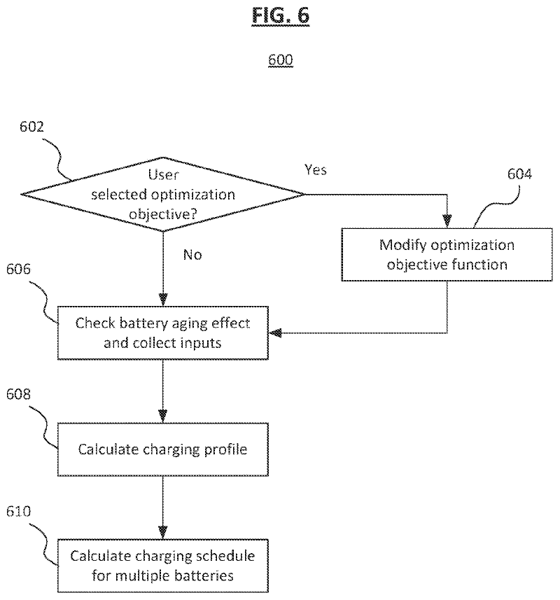

FIG. 6 shows an example of a method 600 implemented by the fleet operator, or more specifically the processing unit thereof, to calculate the charging profile for a fleet of batteries, according to some embodiments. In step 602, the fleet operator determines if the user selected an optimization objective for one or more of the batteries, as previously explained. If the user provided the optimization objective in step 602, in step 604, the optimization objective function (that is, Equation 2) is modified accordingly for the one or more of the batteries for which the user has selected the optimization objective, after which the fleet operator proceeds to step 606. If there is no user-provided objective, the fleet operator proceeds from step 602 to 606. In step 606, the fleet operator checks the aging effect of each of the batteries, for example by the sensors that monitor the health of the battery, and the inputs are collected by the fleet operator. Then, in step 608, the fleet operator uses the inputs to calculate the charging profile for one or more of the batteries. The batteries may each have a different aging effect and SOC, and the fleet operator is capable of intelligently implementing a specialized charging profile for each of the batteries based on factors such as vehicle usage and ambient conditions.

Step 608 utilizes both the battery degradation modeling module 110 to detect or predict the amount of degradation experienced by each of the batteries of the battery fleet system and the aging-aware battery charging strategy module 112 to use the battery degradation information and the inputs to calculate the charging profile of each battery, using the optimization strategy described by Equation 2 as modified accordingly. For example, if the ambient condition is not very aggressive and the delivery task is urgent, the fleet operator may select a minimum-time charging strategy as the charging profile for the particular battery that meets these conditions. The strategy can also make use of the available infrastructures (e.g., charging stations) to coordinate and optimize the battery usage and fleet operation. For example, with the information of the availability of the charging stations, the optimal charging strategy can coordinate with the BMS to calculate the best charging profile, which includes but is not limited to the initial SOC values, the initial cell/module/battery pack temperature(s), and the load of the cooling system for the battery. In some examples, step 610 follows step 608 such that the fleet operator further calculates the charging schedule for the fleet of batteries based on the calculated charging profiles of the batteries. The charging schedule may indicate not only when the batteries are to be charged, but also where and how they are charged (that is, the charging stations and the charging current or power profiles to be used) based on the calculated charging profiles.

As such, in the case of the fleet operator 502, the input information provided to the aging-aware battery charging strategy module 112 may include one or more of the following: fleet operation information, infrastructure availability, ambient conditions, and user inputs. For example, the fleet operation information may include location and route of each of the vehicles that uses a battery that is monitored and managed by the fleet operator. The infrastructure availability may include availability of the charging stations with respect to the distance thereof from the vehicles, and whether or not any of the charging stations are currently being used or are scheduled to be used to charge a battery. Ambient conditions may include weather and road conditions pertaining to the area in which the vehicles are traveling or are scheduled to travel, and user inputs may include the user-selected optimization objective that at least partially affects the charging profile that is to be calculated. In some examples, additional or alternate information provided may include lookahead information, vehicle-to-vehicle (V2V) information, and/or vehicle-to-infrastructure (V2I) information, any of which may indicate whether certain charging stations are already being used by other vehicles, for example.

### Case 3: Aftertreatment Implementation

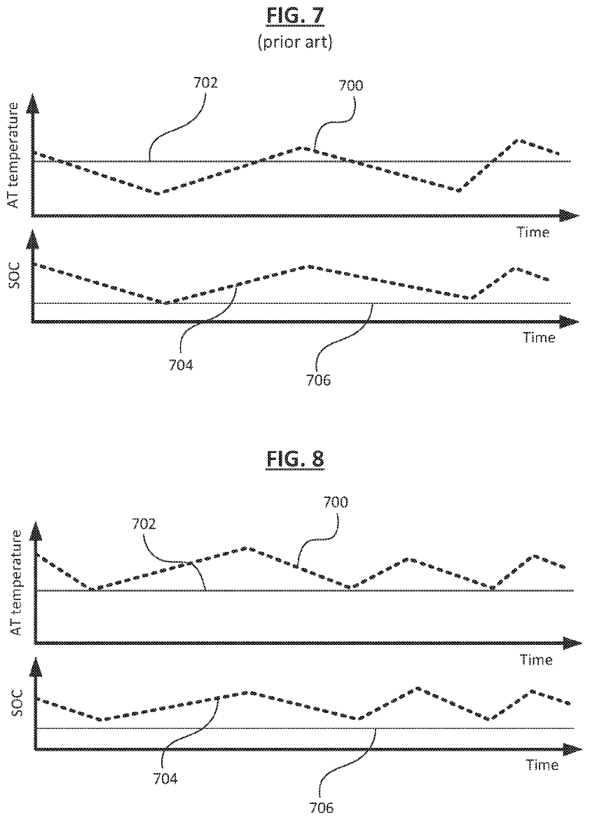

FIGS. 7 and 8 pertain to two different charging strategies for a battery implemented in a range-extended electric vehicle (REEV) or a plug-in hybrid vehicle (PHEV) (PHEV) in which the aftertreatment (AT) temperature of the engine is taken into consideration. For example, in the REEV examples, the battery charger 114 may be a genset which utilizes mechanical energy provided by the engine, e.g., an internal combustion engine (ICE), to power the generator to convert the mechanical energy to electrical energy which can then be stored in the battery 102.

In FIG. 7, an SOC-based battery charging strategy as known in the art is implemented. The strategy involves the steps of: (1) determining or detecting that a battery SOC 704 is approaching a predetermined minimum SOC value 706, and (2) beginning charging the battery when its SOC 704 reaches the minimum SOC value 706. The charging may be performed by the engine providing mechanical power to operate a genset, which converts the mechanical power to electrical power to be stored in the battery, or performed using a plug-in charger. However, doing so without regards to the AT temperature of the vehicle's AT system, which may be a Selective Catalytic Reduction (SCR) system, may cause the vehicle's AT temperature 700 to reach below a predetermined minimum AT temperature value 702, which is undesirable because it causes cold start, which increases the amount of hydrocarbon and NOx emission from the AT system.

In comparison, FIG. 8 implements a charging strategy that considers the AT temperature 700 with respect to the minimum AT temperature 702 in addition to the battery SOC 704 with respect to the minimum SOC value 706. Therefore, when the AT temperature 700 reaches the minimum AT temperature value 702, the battery begins to be charged such that the SOC 704 increases even before reaching the minimum SOC value 706. In fact, in FIG. 8, the SOC 704 never reaches the minimum SOC value 706 in order to maintain the AT temperature 700 constantly at or above the minimum AT temperature 702. In some examples, however, the AT temperature 700 may be high enough to allow the SOC 704 to reach the minimum SOC value 706 before the battery begins charging. The processing unit which oversees the battery charging strategy implements the aging-aware charging strategy to maintain AT temperature at or above the minimum AT temperature (or temperature threshold) while reducing the aging effect of the battery, as previously explained herein.

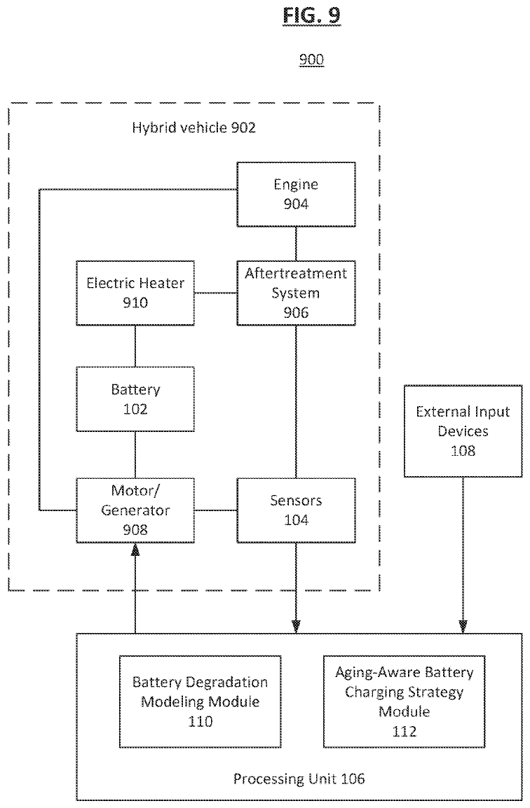

FIG. 9 shows an example of a hybrid vehicle system 900 according to some embodiments. The vehicle system 900 includes a hybrid vehicle 902 with an engine 904 with an AT system 906 as well as a motor/generator 908 which is coupled with the battery 102 to be powered by the battery 102 or to charge the battery 102. In this example, the motor/generator 908, or more specifically when used as a generator, is the battery charger 114 shown in FIG. 1 and is controlled by the processing unit 106. The sensors 104 take measurements from both the battery 102 and the AT system 906. In the aforementioned examples pertaining to the charging strategy of FIG. 8, the input information provided to the aging-aware battery charging strategy module 112 may include one or more of the following: fleet operation information (if the hybrid vehicle 902 is part of a fleet of vehicles), ambient conditions, and other vehicle component status. The other vehicle component status may include the status of AT system 906, catalyst temperature of the AT (SCR) system, and so on. Additional information such as infrastructure availability, charger status, and other user inputs may also be included. The module 112 then outputs a charging profile indicating the charging current, charging power, total charging time, and total capacity loss of the battery.

In some examples, the vehicle system 900 also includes an electric heater 910 operatively coupled with the battery 102 and the AT system 906. The electric heater 910 receives power from the battery 102 to operate such that the electrical heater 910 heats the AT system 906 in order to maintain the AT temperature 700 of the AT system 906 at or above the minimum AT temperature 702 as shown in FIG. 8. For example, this may be facilitated by the processing unit 106 activating the electric heater 910 upon predicting a decrease in the AT temperature 700 below the minimum AT temperature 702. Such activation may occur at a predetermined time before the AT temperature 700 can reach the minimum AT temperature 702, in order to allow the electric heater 910 to properly warm up and provide the necessary heat to increase the AT temperature 700. In some examples, the engine 904 is also operatively coupled with the motor/generator 908 such that the mechanical power provided by the engine 904 is transformed into electrical power using the motor/generator 908, and the electrical power can be used to charge the battery 102 in the way described herein to minimize battery degradation. In some examples, the engine 904 may be activated when the AT temperature 700 reaches a certain level above the minimum AT temperature 702 in order to charge the battery 102 using the motor/generator 908. Thereafter, when the AT temperature 700 decreases and approaches the minimum AT temperature 702, the battery 102 may be used to turn on the electric heater 910 to begin increasing the AT temperature 700 again. In some examples, the engine 904 is configured to charge the battery 102 based on the charging profile in order to minimize battery aging and degradation.

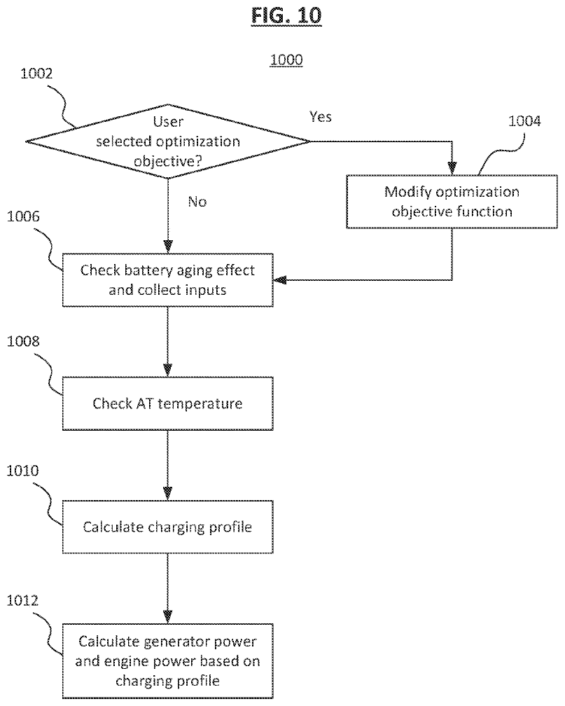

FIG. 10 shows an example of a method 1000 implemented by the processing unit to calculate the charging profile for a battery in view of the AT temperature, according to some embodiments. In step 1002, the processing unit determines if the user selected an optimization objective for the battery, as previously explained. If the user provided the optimization objective in step 1002, in step 1004, the optimization objective function (Equation 2) is modified accordingly, after which the processing unit proceeds to step 1006. If there is no user-provided objective, the processing unit proceeds from step 1002 to 1006. In step 1006, the processing unit checks the aging effect of the battery, for example using sensors whose inputs are collected by the processing unit. In step 1008, the AT temperature is also checked or measured, for example using a thermometer coupled therewith. Then, in step 1010, the processing unit uses the inputs from steps 1006 and 1008 to calculate the charging profile for the battery. The calculated charging profile takes into consideration the AT temperature, the current SOC, and the aging of the battery to reduce further aging of the battery (e.g., by decreasing the magnitude of charging current) and to reduce the NOx emission of the engine (e.g., by facilitating AT temperature increase upon reaching a minimum AT temperature threshold).

In some examples, step 1012 follows step 1010 such that the generator power and the engine power of the range extender are calculated by the processing unit based on the calculated charging profile. As such, the aging-aware optimal charging strategy can generate the optimal charging profile to maintain AT temperature at or above a threshold and facilitate reducing the impact of battery degradation. As determined in step 1012, the engine may be controlled to turn on in order to maintain the AT temperature and to charge the battery. In some examples, an electric heater that is operatively coupled with the aftertreatment system may be turned on or activated to maintain the AT temperature at or above the threshold. The engine power may be selected to minimize battery aging, as determined by the processing unit. In some examples, engine power may be used to power the generator that is operatively coupled with the engine, such that the generator may provide electrical power to charge the battery based on the charging profile as described herein, in order to minimize battery aging and degradation. In some examples, look-ahead information may provide guidance for the target SOC value, which may help enable stop/start of the engine to maintain the AT temperature at or above the threshold and to avoid engine-out NOx (EONOx) generation. Furthermore, in some examples, rule-based charging strategy may be extracted from the optimization result to consider the impact of the effect of the battery's aging.

### Case 4: Regenerative Braking

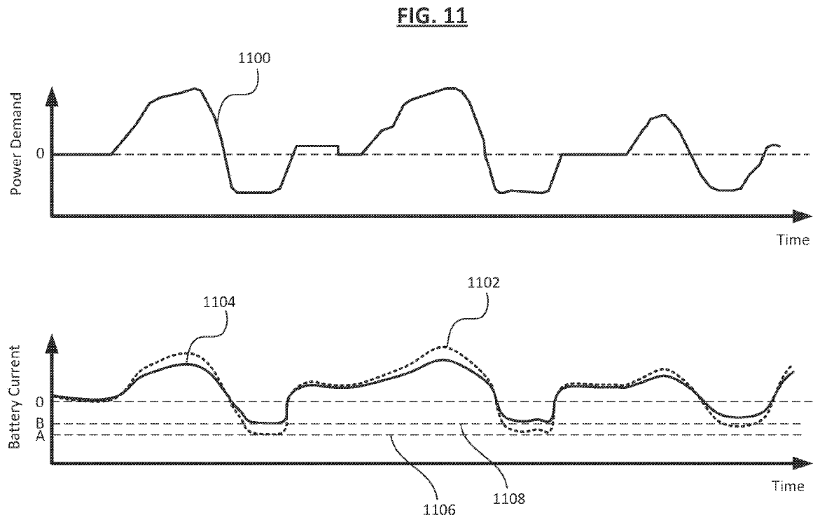

FIG. 11 shows a graph of power demand vs time (top) and another graph of battery current vs time (bottom) comparing the charging profile of two different strategies, according to embodiments disclosed herein. The battery in this example is part of a hybrid electric vehicle (HEV) which may be in a parallel, series, or parallel-series architecture, with capability of capturing regenerative braking energy (mechanical energy) and storing it in the battery as electrical energy for later usage, which is a key functionality to reduce fuel consumption. Therefore, the battery charger 114 in this example is any suitable energy recovery mechanism which facilitates the regenerative braking, e.g., an electric motor that is being used as a generator, as known in the art. However, aggressive regenerative braking events, such as those that facilitate high charging current for battery charging, may lead to severe battery degradation, which in turn may impact the vehicle's total cost of ownership (TCO) and/or reliability.

In the top graph of FIG. 11, a power demand 1100 for the battery is shown as positive power demand (above the zero-watt line, shown with a broken line) or negative power demand (below the broken line). A positive power demand indicates when the vehicle requires the motor to exert mechanical power to meet an increase in demand, e.g. the vehicle experiencing an acceleration or an incline that requires more power, and the battery is required to discharge (i.e., positive battery current) to provide the electrical power for the motor. A negative power demand indicates when the vehicle is decelerating or moving downhill such that there is excess power that needs to be absorbed by activating the brakes, for example. In such instances, regenerative braking may be implemented to facilitate recapturing of the excess power (i.e., negative battery current).

The bottom graph of FIG. 11 shows two strategies that are implemented to control the current flow through the battery. In one strategy, a prior-art fuel-efficient charging profile 1102 is implemented, as shown by the dotted line, which implements the regenerative braking as known in the art, whereas much of the excess power is recaptured to be stored as electrical energy in the battery. In another strategy, an aging-aware charging profile 1104 as calculated by an algorithm is implemented, as shown by the continuous line, which implements the regenerative braking that takes into consideration the aging effect of the battery as well as a measure to facilitate reducing further degradation due to aging, as presently disclosed herein.

In some examples, the algorithm uses an optimization strategy that implements the following equation:

S=min.{(γ+W₁+m_{fuel})+[(1−γ)*W₂+Qₗₒₛₛ]} (Equation 4)

where S is the charging strategy, m_{fuel} is the mass of fuel that is being used by the vehicle, Qₗₒₛₛ is the capacity loss of the battery and is a function of the aging effect of the battery, W₁ is the fuel mass weighting factor, W₂ is the capacity loss weighting factor, and γ is the strategy weight factor. The “min.” indicates the goal of the charging strategy, which is to minimize the values of m_{fuel} and Qₗₒₛₛ based on the value of γ. The strategy weight factor γ affects how much weight is distributed between the charging time and the capacity loss. For example, the first component, γ*W₁*m_{fuel}, pertains to the aging-aware minimum-fuel charging strategy, and the second component, (1−γ)*W*Qₗₒₛₛ, pertains to the aging-aware minimum-capacity-loss charging strategy. In minimum-fuel charging, emphasis is placed on using as little fuel as possible (minimizing or reducing m_{fuel}), therefore increasing the amplitude of the charging current to achieve the same SOC level. In minimum-capacity-loss charging, emphasis is placed on conserving the battery capacity (minimizing or reducing Qₗₒₛₛ) such that the battery life may be prolonged, therefore decreasing the amplitude of the charging current because aggressive regenerative braking contributes to the degradation of the components of the battery, in which case some of the excess power is not reclaimed via regenerative braking. The excess power that is not reclaimed may be absorbed by the engine's hydraulic brakes, thereby causing deceleration.

In some examples, the difference between the two charging profiles 1102 and 1104 lies in the minimum battery current that is reached during battery charging. For example, the prior-art fuel-efficient charging profile 1102 implements aggressive regenerative braking to recapture as much of the kinetic energy as possible, thereby having a negative battery current reaching a lowest threshold 1106 (having the value of “A” amperes) possible. On the other hand, the aging-aware charging profile 1104 implements moderate regenerative braking (compared to the aggressive regenerative braking of the charging profile 1102) such that the lowest battery current is “B” amperes, shown as a threshold 1108, where B>A. In other words, the difference between A and B is the amount of excess power that is not reclaimed by regenerative braking, but absorbed by another method of mechanical braking, such as engaging the engine's hydraulic brakes to cause the deceleration.

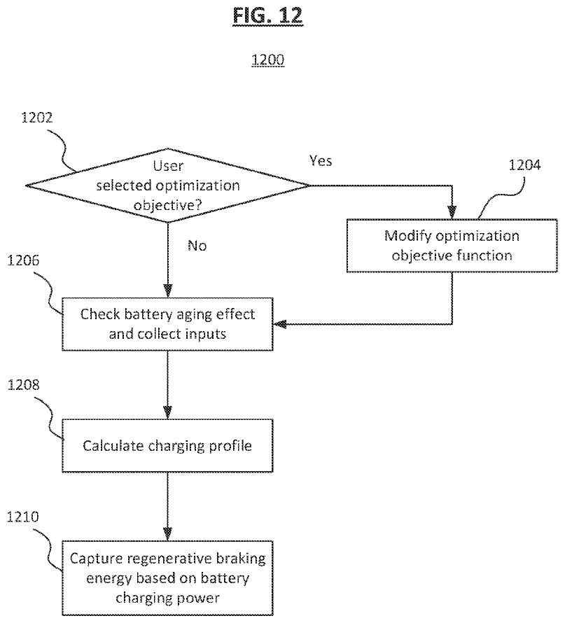

FIG. 12 shows an example of a method 1200 implemented by the processing unit to calculate the charging profile for regenerative braking to be implemented in a battery, according to some embodiments. In step 1202, the processing unit determines if the user selected an optimization objective for the battery, e.g. whether more emphasis is placed on the fuel efficiency or the reduction of battery degradation. If the user provided the optimization objective in step 1202, in step 1204, the optimization objective function (Equation 4) is modified accordingly, after which the processing unit proceeds to step 1206. If there is no user-provided objective, the processing unit proceeds from step 1202 to 1206. In step 1206, the processing unit checks the aging effect of the battery, for example using sensors whose inputs are collected by the processing unit. In step 1208, the processing unit uses the inputs from 1206 to calculate the charging profile for the battery, as disclosed herein.

In step 1210, the regenerative braking is activated to capture the regenerative braking energy based on the battery charging current and the battery charging power based on the charging profile (e.g., maintain the battery current at no lower than “B” amperes as shown in FIG. 11). In such examples, the inputs to the aging-aware battery charging strategy module 112 may include but are not limited to ambient conditions, battery conditions, and other vehicle component status information.

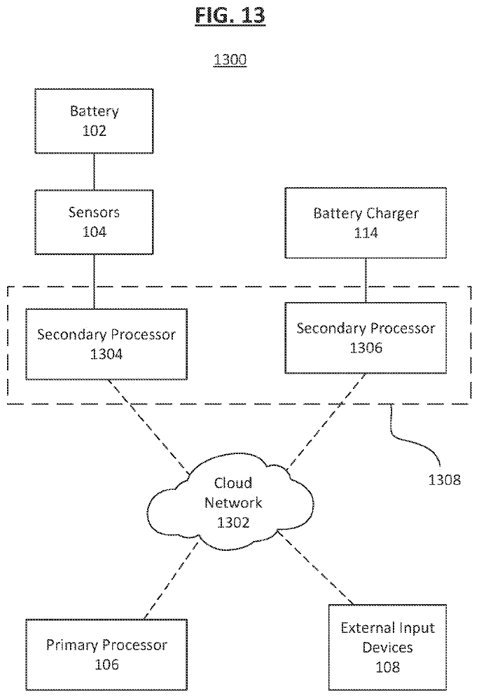

FIG. 13 shows a cloud-implemented system 1300 according to some embodiments disclosed herein. The system 1300 includes a cloud network 1302 or a cloud-based wireless computing network that wireless connects the components shown in FIG. 1. In the example shown, the battery 102 and the sensors 104 are coupled with a secondary processor 1304, and the battery charger 114 is also coupled with a secondary processor 1306. The secondary processors 1304 and 1306 facilitate wireless data transmission between the sensors 104 or the battery charger 114 and the processing unit 106 (herein referred to as a “primary processor” to distinguish from the secondary processors) which includes the battery degradation modeling module 110 and the aging-aware battery charging strategy module 112. Wireless transmissions are shown using broken lines that extend from the cloud network 1302. The secondary processor 1304 allows the sensors 104 to wirelessly transmit measurement data of the battery 102 to the primary processor 106, and the secondary processor 1306 wirelessly receives the charging profile data from the primary processor 106 and uses the charging profile to control how the battery charger 114 charges the battery 102.

In some embodiments, such as in FIG. 9 where the battery charger 114 is the motor/generator 908 and the sensors 104 and the motor/generator 908 are both located on board the hybrid vehicle 902, the secondary processors 1304 and 1306 may be combined into a single secondary processor 1308 that has the capability of both processors 1304 and 1306. In such embodiments, the single secondary processor 1308 is separate from the primary processor 106 such that, instead of calculating the aging-aware charging profile as indicated in FIG. 9, the processor 1308 transmits the sensor measurement data to the cloud network 1302 and receives the charging profile data from the cloud network 1302.

As shown in FIG. 13, the primary processor 106 is located remotely from the battery 102, the sensors 104, and the battery charger 114. The battery degradation modeling module 110 and the aging-aware battery charging strategy module 112, therefore, may receive and transmit data via the cloud network 1302. The external input devices 108 may also be part of the cloud network 1302 such that the devices 108 located remotely from the primary processor 106 are still capable of sending information to the primary processor 106 to be used by the modules 110 and 112.

In some examples, the battery 102 and the sensors 104 are part of a vehicle such as an electric vehicle or hybrid vehicle, and the vehicle has an on-board processor or computing device capable of receiving and transmitting data via wireless communication with the cloud network 1302. In such examples, the on-board processor is the secondary processor 1304 that is separate from the primary processor 106 which contains the modules 110 and 112 but is wirelessly connected thereto. As such, the on-board secondary processor 1304 may be capable of controlling how the battery 102 is charged by either adjusting the electrical current through the battery 102 by increasing or decreasing the resistance at the battery 102, for example, or adjusting the magnitude of electrical current provided by the battery charger 114 to the battery 102.

In other examples, the on-board processor or computing device of the vehicle is the primary processor 106 such that the calculations may be performed inside the vehicle (i.e., replacing the secondary processor 1304 with the primary processor 106). The calculated charging profile may then be transmitted wirelessly from the primary processor 106 via the cloud network 1302 to the secondary processor 1306 coupled with the battery charger 114, such that the secondary processor 1306 may control how the battery charger 114 charges the battery 102 based on the charging profile that is received.

Benefits and advantages of implementing aging-aware battery charging profiles include, but are not limited to, improving vehicle performance as a whole, such as balancing fuel consumption, degradability, durability, and reliability of the vehicle. Also, the economic viability of the product may be improved in view of the payback period of the product, which refers to the amount of time it takes to recover the cost of an investment for the product. The net present value of the product is improved, the warranty cost is reduced, and the prolonged battery life also reduces battery replacement cost.

Exemplary embodiments provide a system and method for aging-aware battery charging profile determination or calculation to be implemented in computer programmable software and stored in computer readable media. Such an embodiment would comprise a computer readable storage medium encoded with computer executable instructions, which when executed by a processor, perform the method for calculating the aging-aware battery charging profile as disclosed above. Many aspects of this disclosure are described in terms of logic units or modules that include sequences of actions to be performed by elements of a control module and/or a network system, which can be a computer system or other hardware capable of executing programmed instructions. These elements can be embodied in a controller of an engine system, such as the ECM, multiple controllers, or in a controller separate from, and communicating with the ECM or distributed across several modules.

In an embodiment, the ECM and other depicted modules can be part of a CAN in which the controller, sensor, actuators communicate via digital CAN messages. It will be recognized that in embodiments consistent with the present disclosure, each of the various actions could be performed by specialized circuits (e.g., discrete logic gates interconnected to perform a specialized function), by program instructions, such as program modules, being executed by one or more processors (e.g., a central processing unit (CPU) or microprocessor), or by a combination of both, all of which can be implemented in a hardware and/or software of the ECM and/or other controller, plural controllers, and/or modules, each of which can utilize a processor or share a processor with another unit (module, controller etc.) to perform actions required. For example, the battery degradation modeling module 110 and the aging-aware battery charging strategy module 112 can be implemented as separate modules, and each module can be part of the ECM or as a separately provided module.

Logic of embodiments consistent with the disclosure can be implemented with any type of appropriate hardware and/or software, with portions residing in the form of computer readable storage medium with a control algorithm recorded thereon such as the executable logic and instructions disclosed herein, and can be programmed, for example, to include one or more singular or multi-dimensional engine and turbine look-up tables and/or calibration parameters. The computer readable medium may comprise tangible forms of media, for example, a random access memory (RAM), a read-only memory (ROM), an erasable programmable read-only memory (e.g., EPROM, EEPROM, or Flash memory), an optical fiber, and a portable compact disc read-only memory (CD-ROM), or any other solid-state, magnetic, and/or optical disk medium capable of storing information. Thus, various aspects can be embodied in many different forms, and all such forms are contemplated to be consistent with this disclosure.

Although the examples and embodiments have been described in detail with reference to certain preferred embodiments, variations and modifications exist within the spirit and scope of the disclosure as described and defined in the following claims.

1. A system for charging a battery, comprising:
a plurality of sensors coupled with the battery;
at least one battery charger coupled with the battery; and
a processing unit coupled with the sensors and the battery charger, the processing unit comprising a battery degradation modeling module and an aging-aware battery charging strategy module, the processing unit configured to:
receive sensor information from the sensors;
detect, using the battery degradation modeling module, aging phenomena or mechanisms that cause aging effect of the battery using a degradation model of the battery based on the sensor information;
calculate, using the aging-aware battery charging strategy module, a charging profile for the battery based on the aging effect of the battery and the sensor information; and
control the battery charger to charge the battery based on the charging profile.

2. The system of claim 1, wherein the aging effect includes one or more of: capacity loss, power loss, or internal resistance increase within the battery.

3. The system of claim 2, wherein the aging phenomenon or mechanism includes one or more of: electrolyte oxidation, transition metal dissolution, anode or cathode film growth, or active material loss within the battery.

4. The system of claim 2, wherein the battery is a lithium-ion battery and the aging phenomenon or mechanism includes one or more of: solid electrolyte interphase (SEI) layer growth, cathode film growth, active material loss, dendrite growth, or lithium plating within the battery.

5. The system of claim 1, wherein the charging profile includes battery charging current or power values and a degradation status of the battery.

6. The system of claim 1, wherein the at least one battery charger comprises a plurality of charging stations for a corresponding plurality of the vehicles, and the charging profile comprises a plurality of charging profiles for a plurality of batteries corresponding to the plurality of vehicles.

7. The system of claim 6, wherein the processing unit is further configured to calculate a charging schedule for the vehicles using the charging stations based on the charging profiles.

8. A method of charging a battery comprising:
receiving, by a processing unit, sensor information from a plurality of sensors coupled with the battery;
detecting, by a battery degradation modeling module of the processing unit, aging phenomena or mechanisms that cause aging effect of the battery using a degradation model of the battery based on the sensor information;
calculating, by an aging-aware battery charging strategy module of the processing unit, a charging profile for the battery based on the aging effect of the battery and the sensor information; and
controlling a battery charger coupled with the battery to charge the battery based on the charging profile.

9. The method of claim 8, wherein aging effect includes one or more of: capacity loss, power loss, or internal resistance increase within the battery, and the aging phenomenon or mechanism includes one or more of: electrolyte oxidation, transition metal dissolution, anode or cathode film growth, or active material loss within the battery.

10. The method of claim 8, further comprising:
calculating, by the aging-aware battery charging strategy module, a plurality of charging profiles for a plurality of batteries implemented in a plurality of vehicles, wherein the charging profiles are based on the aging effect of the batteries; and
calculating, by the aging-aware battery charging strategy module, a charging schedule for a plurality of vehicles based on the charging profiles.

11. The method of claim 8, the battery implemented in a hybrid vehicle comprising an engine, an aftertreatment system coupled with the engine and the sensors, and a motor/generator coupled with the battery, the method further comprising:
receiving, by the processing unit, sensor information from the sensors coupled with the aftertreatment system;
calculating, by the aging-aware battery charging strategy module, a charging profile for the battery based on the aging effect of the battery and the sensor information associated with the aftertreatment system.

12. The method of claim 11, further comprising:
calculating, by the processor, a generator power and an engine power based on the charging profile, wherein the calculated generator power and the engine power facilitate maintaining the aftertreatment system at or above a minimum threshold temperature.

13. The method of claim 12, further comprising:
activating, by the processor, an electric heater operatively coupled with the aftertreatment system to maintain the aftertreatment system at or above the minimum threshold temperature.

14. The method of claim 12, further comprising:
controlling, by the processor, the engine to provide mechanical power to the motor/generator to charge the battery based on the charging profile.

15. The method of claim 12, further comprising:
controlling, by the processor, the motor/generator to capture regenerative braking energy based on the charging profile.

16. The method of claim 8, wherein the processor, the battery, and the battery charger are wirelessly connected via a cloud network, the processor located remotely from the battery and the battery charger, the method further comprising:
wirelessly receiving, by the processor via the cloud network, the sensor information from the sensors coupled with the battery,
wirelessly transmitting, by the processor via the cloud network, the calculated charging profile to a secondary processor coupled with the battery or the battery charger, and
controlling, by the secondary processor, charging of the battery based on the charging profile.

17. A hybrid vehicle system comprising:
a hybrid vehicle comprising an engine, an aftertreatment system coupled with the engine, a motor/generator, at least one battery coupled with the motor/generator, an electric heater, and a plurality of sensors coupled with the battery and the aftertreatment system;
a processing unit coupled with the sensors and the motor/generator, the processing unit comprising a battery degradation modeling module and an aging-aware battery charging strategy module; and
a non-transient computer readable storage medium storing instructions thereon which when run by the processing unit causes the processing unit to perform the method of claim 8.
